(19) United States
(12) Patent Application Publication
(10) Pub. No.: US 2025/0190754 A1
(43) Pub. Date: Jun. 12, 2025

(54) SYNTHETIC TIME SERIES DATA GENERATION

(71) Applicant: The Boeing Company, Arlington, VA (US)

(72) Inventor: Johnathan David SVOBODA-JAMES, Colorado Springs, CO (US)

(73) Assignee: The Boeing Company, Arlington, VA (US)

(21) Appl. No.: 18/532,352

(22) Filed: Dec. 7, 2023

(51) Int. Cl. G06N 3/0442

(52) U.S. Cl. CPC G06N 3/0442

(57) ABSTRACT

According to various embodiments, a computer-implemented machine learning system for, and method of, generating synthetic time series data are presented. The system includes: an embedder network that inputs multivariate time series data and produces latent representations capturing temporal dependencies, where the multivariate time series data comprises initial multivariate time series data; a recovery network that produces reconstructed multivariate time series data from the latent representations, where the recovery network employs a plurality of time-distributed dense layers that maintain statistical properties; and a generator network that synthesizes synthetic multivariate time series data from the latent representations, where the synthetic multivariate time series data reflects temporal patterns of the initial multivariate time series data.

### FIELD

This disclosure relates generally to machine learning, including obtaining data used to train machine learning systems.

### BACKGROUND

Time series data is ubiquitous in various domains, ranging from aviation to finance and healthcare to energy to weather forecasting. Analyzing and understanding the underlying patterns, trends, and dependencies in time series data is important for making informed decisions, developing accurate predictive models, and gaining insights into the dynamics of the observed phenomena. However, obtaining real-world time series data can often be challenging due to several factors, including privacy concerns, limited data availability, and the high costs associated with data collection and maintenance.

In recent years, synthetic time series data generation has emerged as a promising approach to address the challenges of data availability, privacy preservation, and algorithm evaluation. Synthetic data refers to artificially generated data that mimics the statistical properties and temporal dynamics of real-world data. By generating synthetic time series data, researchers and practitioners can overcome data scarcity issues, perform rigorous evaluations, and explore alternative scenarios without compromising the privacy of individuals or organizations.

While traditional approaches for synthetic data generation, such as interpolation or resampling, have been widely used, they often fail to capture the complex dependencies and temporal patterns present in time series data. Additionally, these approaches may overlook higher-dimensional structures and statistical properties, limiting their usefulness for generating realistic and diverse synthetic time series data. To address these limitations, researchers have turned to generative models, such as Variational Autoencoders (VAEs) and Generative Adversarial Networks (GANs), which have shown promise in generating synthetic data.

However, existing generative models face challenges when applied to time series data generation. VAEs and GANs struggle to capture the intricate temporal dependencies and high-dimensional structures present in time series data. Moreover, they often fail to preserve the statistical properties and long-term correlations that characterize real-world time series data. These limitations pose significant barriers to achieving high-quality synthetic time series data that can be effectively utilized for various applications.

### SUMMARY

According to various embodiments, a computer-implemented machine learning system for generating synthetic time series data is presented. The system includes: an embedder network that inputs multivariate time series data and produces latent representations capturing temporal dependencies, where the multivariate time series data comprises initial multivariate time series data; a recovery network that produces reconstructed multivariate time series data from the latent representations, where the recovery network employs a plurality of time-distributed dense layers that maintain statistical properties; and a generator network that synthesizes synthetic multivariate time series data from the latent representations, where the synthetic multivariate time series data reflects temporal patterns of the initial multivariate time series data.

Various optional features of the above embodiments include the following. The embedder network may include a series of long short-term memory (LSTM) layers to encode the initial multivariate time series data into a lower-dimensional latent space, capturing both short-term and long-term temporal dependencies. The recovery network may utilize a combination of LSTM layers and time-distributed dense layers to decode the latent representations into decoded multivariate time series data, where the decoded multivariate data aligns with temporal and statistical characteristics of the initial multivariate time series data. The generator network may be trained adversarially in conjunction with a discriminator network, where the discriminator network is trained to differentiate between authentic and synthetic multivariate time series data. The embedder network and the recovery network may undergo, prior to the generator network being trained adversarially in conjunction with the discriminator network, an initial training phase to stabilize latent space representations. The system may include a Bayesian network that models conditional probability distributions and causal relationships within the initial multivariate time series data. The system may include an integration of components from a temporal generative adversarial network (TimeGAN), a variational autoencoder (VAE), and a recurrent neural network (RNN). The synthetic multivariate time series data may be used to train a separate machine learning model. The synthetic multivariate time series data may include aircraft time series data. The synthetic multivariate time series data may include at least two of: parametric aircraft data, aircraft fault data, aircraft maintenance data, aircraft binary data, or aircraft flight data.

According to various embodiments, a non-transitory computer readable medium comprising instructions that, when executed by an electronic processor, configure the electronic processor as a computer-implemented machine learning system for generating synthetic time series data is presented. The system includes: an embedder network that inputs multivariate time series data and produces latent representations capturing temporal dependencies, where the multivariate time series data comprises initial multivariate time series data; a recovery network that produces reconstructed multivariate time series data from the latent representations, where the recovery network employs a plurality of time-distributed dense layers that maintain statistical properties; and a generator network that synthesizes synthetic multivariate time series data from the latent representations, where the synthetic multivariate time series data reflects temporal patterns of the initial multivariate time series data.

Various optional features of the above embodiments include the following. The embedder network may include a series of long short-term memory (LSTM) layers to encode the initial multivariate time series data into a lower-dimensional latent space, capturing both short-term and long-term temporal dependencies. The recovery network may utilize a combination of LSTM layers and time-distributed dense layers to decode the latent representations into decoded multivariate time series data, where the decoded multivariate data aligns with temporal and statistical characteristics of the initial multivariate time series data. The generator network may be trained adversarially in conjunction with a discriminator network, where the discriminator network is trained to differentiate between authentic and synthetic multivariate time series data. The embedder network and the recovery network may undergo, prior to the generator network being trained adversarially in conjunction with the discriminator network, an initial training phase to stabilize latent space representations. The system may further include a Bayesian network that models conditional probability distributions and causal relationships within the initial multivariate time series data. The system may include an integration of components from a temporal generative adversarial network (TimeGAN), a variational autoencoder (VAE), and a recurrent neural network (RNN). The synthetic multivariate time series data may be used to train a separate machine learning model. The synthetic multivariate time series data may include aircraft time series data. The synthetic multivariate time series data may include at least two of: parametric aircraft data, aircraft fault data, aircraft maintenance data, aircraft binary data, or aircraft flight data.

Combinations, (including multiple dependent combinations) of the above-described elements and those within the specification have been contemplated by the inventors and may be made, except where otherwise indicated or where contradictory.

### BRIEF DESCRIPTION OF THE DRAWINGS

Various features of the examples can be more fully appreciated, as the same become better understood with reference to the following detailed description of the examples when considered in connection with the accompanying figures, in which:

FIG. 1 is a schematic diagram of a system for generating synthetic time series data according to various embodiments;

FIG. 2 is a process diagram of a system for generating synthetic time series data according to various embodiments; and

FIG. 3 is a schematic diagram of computer hardware suitable for implementing a system for generating synthetic time series data according to various embodiments.

### DESCRIPTION OF THE EXAMPLES

Reference will now be made in detail to example implementations, illustrated in the accompanying drawings. Wherever convenient, the same reference numbers will be used throughout the drawings to refer to the same or like parts. In the following description, reference is made to the accompanying drawings that form a part thereof, and in which is shown by way of illustration specific exemplary examples in which the invention may be practiced. These examples are described in sufficient detail to enable those skilled in the art to practice the invention and it is to be understood that other examples may be utilized and that changes may be made without departing from the scope of the invention. The following description is, therefore, merely exemplary.

Some embodiments provide a comprehensive framework for synthetic time series data generation. By integrating elements of VAEs, GANs, and Bayesian Networks, some embodiments capture the underlying structure, preserve the statistical properties, and generate high-quality synthetic time series data that closely resemble the characteristics of real-world data.

Some embodiments leverage the strengths of VAEs to encode and decode time series data, capturing their latent representations and learning the underlying probability distributions. Some embodiments incorporate GANs to generate diverse and realistic synthetic samples by training a generator network to produce time series data that is difficult to distinguish from real data, while a discriminator network provides feedback to enhance the quality of the generated samples. Some embodiments employ Bayesian networks to model the dependencies and causal relationships among the time series variables, further improving the ability to capture the complex dynamics and generate coherent synthetic sequences.

By integrating these techniques, some embodiments overcome the limitations of existing methods and provide a robust framework for synthetic time series data generation. The ability of some embodiments to generate realistic synthetic time series data has the potential to improve various domains, including finance, healthcare, energy, aviation, and more. Come embodiments can facilitate research by providing a virtually unlimited source of realistic data for testing and validation. Furthermore, some embodiments allow organizations to comply with privacy regulations while still deriving valuable insights from synthetic data.

Some embodiments significantly improve data fidelity by generating synthetic time series data that faithfully captures the underlying characteristics of the original data. Through the use of VAEs, some embodiments learn the latent representations and probability distributions of the data. This allows for the generation of synthetic sequences that exhibit similar statistical properties, such as means, variances, and correlations, as the original data. The incorporation of GANs further enhances data fidelity by training the generator network to produce samples that are indistinguishable from real data, resulting in high-quality synthetic sequences.

Some embodiments preserve the temporal dynamics present in time series data. By integrating Long Short-Term Memory (LSTM)-based architectures some embodiments capture the complex dependencies and long-term correlations inherent in time series data. The LSTM layers allow some embodiments to learn the temporal patterns and capture the sequential nature of the data, allowing for the generation of synthetic sequences that retain the temporal dynamics observed in the original data. This preservation of temporal dynamics contributes to the generation of realistic and meaningful synthetic time series data.

Some embodiments incorporate Bayesian networks to model the causal relationships among the time series variables. This integration enhances the interpretability and explainability of the synthetic time series data. By capturing the dependencies and causal structure of the data, the Bayesian networks component provides insights into the underlying data generation process. Some embodiments can identify influential features, analyze the effects of interventions, and generate coherent sequences that align with the causal structure of the data. This contributes to a deeper understanding of the data and enhances the trustworthiness and usability of the synthetic time series data.

Some embodiments offer practical applications in various domains. The ability to generate realistic synthetic time series data can be leveraged for a range of purposes, including privacy preservation, data augmentation, simulation, anomaly detection, and more. In privacy-sensitive domains, some embodiments allow data holders to share synthetic data that preserves the statistical properties and temporal dynamics of the original data without disclosing sensitive information. The generated synthetic data can also be used for data augmentation to overcome data scarcity issues, simulation for scenario analysis, and anomaly detection to improve outlier detection algorithms. For example, some embodiments may generate synthetic time series data, e.g., in the aviation domain, that can then be used to train other machine learning models.

These and other features and advantages are shown and described herein in reference to the figures.

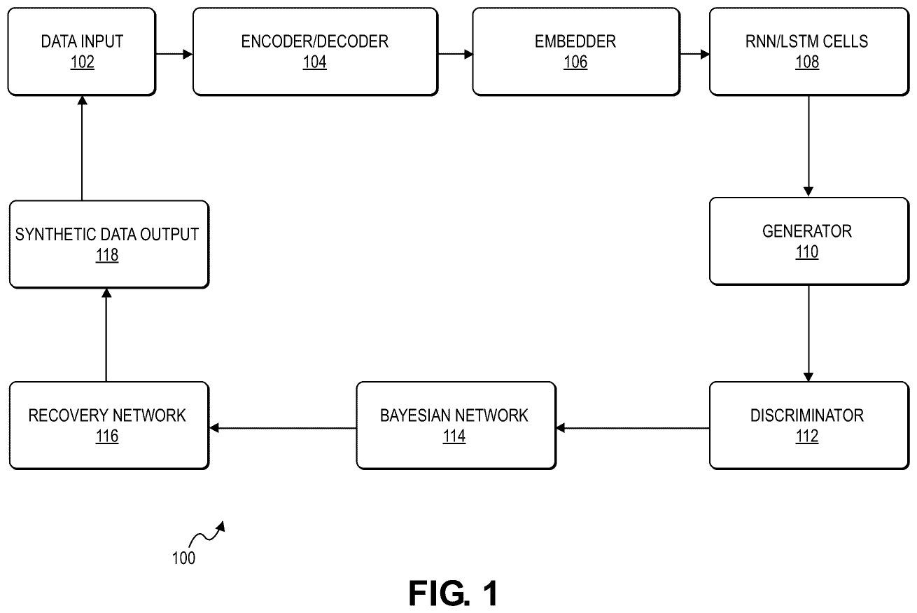

FIG. 1 is a schematic diagram of a system 100 for generating synthetic time series data according to various embodiments. The system 100 leverage the strengths of VAEs, GANs, and Bayesian networks while addressing the limitations of existing approaches. It combines the representation learning capabilities of VAEs, the adversarial training of GANs, and the probabilistic modeling of Bayesian networks to generate synthetic time series data that preserves the underlying structure, statistical properties, and temporal dependencies of the real data. By combining these techniques, the system 100 aims to capture complex dependencies, preserve statistical properties, and generate realistic synthetic time series sequences that closely resemble the characteristics of the real data. The architecture of the system 100 includes three main components: an embedder network 106, a recovery network 116, and a generator network 110. These and other components perform the data generation process as disclosed herein.

The system 100 accepts timer series data as a data input 102, which may serve as a catalyst to generate synthetic time series data. The data input 102 is passed to the encoder/decoder components 104 of a VAE. The encoder network maps the input time series data to a latent space, while the decoder network reconstructs the data from the latent space.

The embedder network 106 serves as the initial stage of the system 100. Its primary role is to extract a meaningful and compact representation of the input time series data. The embedder network 106 includes VAE components and learns the latent representation of the input time series data. It utilizes Long Short-Term Memory (LSTM) layers 108 to capture temporal dependencies and encode the input sequences into a lower-dimensional latent space. These LSTM layers 108 allow the system 100 to effectively capture long-term dependencies and extract relevant features from the time series data. The embedder network 106 learns to map the input time series data to a compact and meaningful representation, allowing for effective information compression and feature extraction. This latent representation serves as a foundation for subsequent stages of data generation. The output of the embedder network 106 is the latent representation, which encapsulates the key characteristics and underlying patterns of the input data.

The recovery network 116 includes VAE components and acts as the decoder counterpart to the embedder network 106. It takes the latent representation produced by the embedder network 106 and reconstructs the original time series data. The recovery network 116 employs LSTM layers 108 and time-distributed dense layers to decode the latent representation and generate synthetic sequences that closely resemble the input data. By reconstructing the original data, the recovery network 116 ensures that the system 100 captures the statistical properties, temporal dynamics, and other key features of the real data, preserving its underlying structure. This reconstruction process helps validate the fidelity of the generated synthetic sequences.

The generator network 110 includes GAN components and focuses on generating diverse and realistic synthetic time series sequences. It takes the latent representation generated by the embedder network 106 and employs LSTM layers 108 to generate a sequence of synthetic data points. The generator network 110 learns to capture the temporal dependencies and dynamics of the real data, producing sequences that exhibit similar patterns and statistical properties. The generator network 110 is trained in an adversarial manner, where a discriminator 112 is simultaneously trained to distinguish between real and synthetic sequences. This adversarial training enhances the quality and realism of the generated synthetic data, allowing the generator network 110 to continually improve its data generation capabilities.

The system 100 also integrates a Bayesian network 114 to capture dependencies and probabilistic modeling. The Bayesian network 114 provides a structured and interpretable framework to model the conditional dependencies between variables in the time series data. By incorporating the Bayesian network 114, the system 100 enhances its ability to generate synthetic sequences that adhere to the observed dependencies and statistical properties. This integration adds a probabilistic modeling aspect to the system 100, allowing for the generation of data sequences that align with the underlying probabilistic structure of the real data. The Bayesian network 114 complements the VAE and GAN components by providing a probabilistic framework for modeling the time series data and generating synthetic sequences that reflect the observed statistical patterns.

The system 100 produces synthetic time series data 118, which is passed back to the system 100 as a data input 102. This cycle can continue until the synthetic data output 118 is suitable for use.

The integration of the embedder network 106, the generator network 110, and the recovery network 116 components within the system 100 offers several advantages. VAEs allow for effective feature extraction and information compression, allowing the model to capture the underlying structure and preserve important features of the real data. GANs provide the ability to generate diverse and realistic synthetic sequences by training the generator network 110 and the discriminator 112 in an adversarial manner, leading to improved data quality and diversity. The Bayesian network 114 contribute to capturing complex dependencies and providing a probabilistic framework for modeling the data, enhancing the ability of the system 100 to generate synthetic sequences that reflect the observed statistical patterns.

The components of the system 100 work in synergy, with the embedder network 106 extracting meaningful representations, the recovery network 116 ensuring accurate reconstruction, and the generator network 110 generating diverse and realistic synthetic sequences. The integration of VAEs, GANs, and Bayesian networks components creates a comprehensive framework that combines the strengths of each technique, resulting in a powerful approach for synthetic time series data generation.

The components of the system 100 interact synergistically to achieve the goal of generating realistic synthetic time series data. The embedder network 106 extracts a meaningful latent representation from the input data, capturing the essential features and temporal dependencies. This latent representation is then passed to both the recovery network 116 and to the generator network 110. The recovery network 116 decodes the latent representation and reconstructs the original time series data. This reconstruction process helps ensure that the system 100 captures the statistical properties and underlying structure of the real data. The generator network 110 takes the latent representation and generates diverse and realistic synthetic sequences. The generator network 110 learns to capture the temporal dependencies, patterns, and statistical characteristics of the real data, producing synthetic sequences that closely resemble the input data. The interactions between the generator network 110 and the discriminator 112, trained in an adversarial manner, further enhance the quality and diversity of the generated synthetic data. The adversarial training process encourages the generator network 110 to improve its data generation capabilities, making the synthetic sequences more realistic and indistinguishable from the real data.

A description of training the system 100 follows. The training process involves iteratively updating the system's parameters to optimize the performance and generate high-quality synthetic time series data. The training process comprises several steps, including pre-training, adversarial training, and fine-tuning. These steps are performed in a coordinated manner to ensure that the system 100 learns the underlying structure and statistical properties of the real data.

The initial phase of training involves pre-training the embedder network 106 and the recovery network 116. This pre-training aims to reconstruct the input time series data accurately. It utilizes a combination of supervised learning and unsupervised learning techniques, such as mean squared error (MSE) loss, to minimize the discrepancy between the original data and the reconstructed sequences. Pre-training the embedder network 106 and the recovery network 116 helps in capturing the key features and temporal dependencies of the real data.

Once the embedder network 106 and the recovery network 116 are pre-trained, the adversarial training phase begins. This phase focuses on training the generator network 110 and the discriminator 112 in an adversarial manner. The generator network 110 aims to generate synthetic time series sequences that closely resemble the real data, while the discriminator 112 aims to distinguish between the real and synthetic sequences. The generator network 110 and the discriminator 112 are trained simultaneously, with the generator network 110 striving to deceive the discriminator 112, and the discriminator 112 striving to accurately classify the sequences. This adversarial training process leads to an improved generator network 116 that generates increasingly realistic and diverse synthetic sequences.

During the adversarial training, the system 100 employs optimization techniques, such as the Adam optimizer. The Adam optimizer adapts the learning rate based on the gradients and momentum, facilitating efficient convergence and optimization of the model's parameters. The training process involves iteratively updating the weights of the embedder 112106 recovery network 116, generator network 110, and discriminator 112 using backpropagation and gradient descent.

Following the adversarial training, the fine-tuning phase is performed to refine the performance of the system 100 further. Fine-tuning involves jointly optimizing all components of the system 100 while considering the interactions between them. This phase aims to enhance the overall performance and generate synthetic time series data that closely adhere to the statistical properties and dependencies of the real data.

The system 100 employs several loss functions to guide the training process and assess the quality of the generated synthetic sequences. These loss functions play a role in aligning the synthetic data with the characteristics of the real data and encouraging the generator network 110 to generate high-quality sequences.

In the pre-training phase, the mean squared error (MSE) loss is commonly used to measure the discrepancy between the original data and the reconstructed sequences. The MSE loss ensures that the embedder 106 and the recovery network 116 accurately capture the key features and temporal dependencies of the real data during the pre-training process.

During the adversarial training phase, the generator network 110 and the discriminator 112 utilize the binary cross-entropy loss. The binary cross-entropy loss measures the dissimilarity between the predicted labels (real or synthetic) and the true labels. The generator network 110 aims to minimize this loss, indicating that the synthetic sequences are classified as real by the discriminator 112. Conversely, the discriminator 112 aims to maximize this loss, accurately distinguishing between the real and synthetic sequences.

Additionally, the system 100 incorporates other loss functions specific to each component. The embedder network 106 and the recovery network 116 utilize auxiliary loss functions, such as mean squared error (MSE) or mean absolute error (MAE), to enforce the accurate reconstruction of the input data. These auxiliary loss functions guide the embedder network 106 and the recovery network 116 in preserving the statistical properties and temporal dynamics of the real data.

One of the strengths of the system 100 lies in its interpretability. The integration of VAEs, GANs, and Bayesian Networks within the system 100 allows for the capture of complex dependencies and probabilistic modeling. This integration provides interpretability benefits, allowing users to gain insights into the underlying structure and statistical properties of the generated synthetic time series data.

The embedder network 106 plays a role in interpretability by extracting a meaningful latent representation of the input data. This latent representation encodes the essential features and temporal dependencies, making it easier to understand and interpret the characteristics of the synthetic sequences. Users can analyze the latent space and visualize the distribution of the latent variables to gain insights into the variability and clustering patterns within the synthetic data.

The Bayesian network 114 further enhances interpretability by capturing the conditional dependencies between variables in the time series data. The learned Bayesian network 114 can provide a graphical representation of the relationships between variables, enabling researchers to understand the causal relationships and influences within the generated synthetic data.

To ensure the compatibility and quality of the data, preprocessing steps may be applied to the datasets before training and evaluation. The preprocessing steps may include any, or a combination, of the following:

1. Data Cleaning: The datasets may contain missing values, outliers, or noise. Data cleaning techniques, such as imputation or outlier detection, may be employed to handle these issues and ensure the integrity of the data.

2. Normalization: Time series data often exhibit different scales and ranges. Normalization techniques, such as Min-Max scaling or z-score normalization, may be applied to standardize the data and bring them within a consistent range.

3. Temporal Resampling: The datasets may have varying time intervals or irregular time steps. Temporal resampling techniques, such as interpolation or downsampling, may be employed to achieve a uniform time resolution for the data.

4. Feature Engineering: Additional features or transformations may be derived from the original data to capture specific domain knowledge or enhance the model's performance. Feature engineering techniques, such as Fourier transforms, wavelet analysis, or trend extraction, may be applied to extract relevant features or representations from the time series data.

5. Train-Test Split: The datasets are typically divided into training and testing sets. The training set may be used to train the system 100, while the testing set may be used to evaluate its performance. The split ensures that the generalization ability of the system 100 is assessed on unseen data.

The preprocessing steps applied to the datasets depend on the specific characteristics and requirements of each dataset and the goals of the evaluation. These steps aim to enhance the quality, consistency, and suitability of the data for training and evaluating the system 100.

A description of various applications of the system 100 and example use cases follows.

The system 100 may be used to generate privacy-preserving synthetic time series data. In many domains, organizations possess sensitive and confidential time series data that cannot be shared directly due to privacy regulations, security concerns, or legal constraints. However, there is a growing demand for access to such data for research, analysis, and the development of innovative solutions. Privacy-preserving synthetic data generation techniques, such as by the system 100, offer a viable solution by generating synthetic time series data that closely resemble the original data while ensuring privacy. Example use cases for privacy-preservice synthetic time series generation include the following.

1. Healthcare: In the healthcare industry, there is a need for synthetic data to facilitate research, algorithm development, and data sharing without violating patient privacy. The system 100 can generate realistic synthetic time series data that retains the statistical properties and temporal dependencies of real patient data, enabling healthcare organizations to share and analyze data while preserving privacy.

2. Financial Services: Financial institutions deal with sensitive financial transactions and customer information. Synthetic time series data generated by the system 100 can be used to develop and test financial models, fraud detection algorithms, and risk assessment strategies without exposing real customer data to potential security breaches.

3. Smart Grids: Smart grid systems collect vast amounts of data related to electricity consumption, grid performance, and user behavior. Privacy-preserving synthetic time series data generated by the system 100 can be employed for research, testing energy management algorithms, and developing optimization strategies while protecting the privacy of individuals and organizations.

4. Aviation: Aircraft systems generate huge amounts of data, e.g., through aircraft sensors. The system 100 may be used to generate aircraft time series data, such as parametric aircraft data, aircraft fault data, aircraft maintenance data, aircraft binary data, or aircraft flight data. The aircraft time series data may be for a single aircraft, multiple aircraft, or a fleet of aircraft.

The system 100 may be used to generate synthetic time series data for data augmentation. Data augmentation involves expanding the size and diversity of existing datasets by generating synthetic data that closely resembles the original data. By employing the system 100, users can augment their time series datasets, leading to several advantages:

1. Increased Sample Size: The system 100 generates synthetic time series data that expands the dataset, allowing for larger sample sizes. This increase in data volume enhances the statistical significance of analyses and facilitates more robust model training.

2. Enhanced Generalization: Augmented data introduces more variation and diversity into the dataset, aiding the generalization capabilities of machine learning models. By incorporating synthetic data, models trained on augmented datasets are better equipped to handle unseen patterns and outliers.

3. Improved Model Performance: The augmented data can enhance model performance by reducing overfitting and bias. The additional synthetic samples provide a broader representation of the underlying data distribution, allowing models to learn more effectively.

Synthetic time series data generated by the system 100 can be employed to simulate various scenarios and evaluate system performance. This simulation-driven approach offers several practical applications in different fields:

1. Risk Assessment and Planning: In finance and insurance, synthetic time series data generated by the system 100 can be used to simulate different market conditions, assess risk exposure, and evaluate investment strategies. These simulations enable organizations to make informed decisions, optimize portfolios, and plan for potential scenarios.

2. Process Optimization: The system 100 can generate synthetic time series data that resembles real-world sensor data from industrial processes or complex systems. This synthetic data can be used for simulation-based optimization, enabling organizations to identify optimal process settings, minimize downtime, and improve efficiency.

3. Healthcare Research and Analysis: Synthetic time series data can facilitate research in healthcare by simulating patient health profiles, disease progression, or treatment outcomes. Researchers can leverage the system 100 to generate diverse synthetic data that mimics real patient data, allowing for studies on treatment effectiveness, clinical trials, and healthcare resource planning.

The system 100 may be used to detect anomalies in time series data. By training on a large set of normal time series data, the system 100 learns the underlying patterns and dependencies. When presented with new data, the system 100 can identify deviations from these learned patterns, flagging them as potential anomalies. The benefits of using the system 100 for anomaly detection include:

1. Early Warning System: The system 100 can act as an early warning system by detecting anomalies at an early stage. Users can identify and address abnormal events or behaviors promptly, mitigating potential risks and minimizing the impact of anomalous occurrences. Example applications include detecting anomalies in aircraft components, such as sensors.

2. Unsupervised Anomaly Detection: The system 100 operates in an unsupervised manner, meaning it can detect anomalies without the need for labeled training data. This flexibility allows for the detection of unknown or novel anomalies, making it suitable for real-world scenarios where new types of anomalies may emerge.

3 Contextual Anomaly Detection: The system 100 captures temporal dependencies and contextual information in time series data. This allows for the detection of context-specific anomalies that may vary based on different conditions or contexts.

The system 100 may be used to generate novel time series data. By leveraging the learned patterns and dependencies, the system 100 can generate synthetic data points that deviate from the observed patterns. These novel data points can introduce new patterns, variations, or trends that were not present in the original dataset. The benefits and applications of novelty generation using the system 100 include:

1. Data Exploration and Scenario Analysis: The generation of novel time series data allows organizations to explore alternative scenarios and analyze the potential impact of novel events or trends. This assists in decision-making, risk assessment, and strategic planning by providing insights into potential future trajectories.

2. Synthetic Data Generation for Innovation: The system's ability to generate novel data points can be utilized for innovation and creativity. Users can leverage the model to generate new and unique time series data that inspires the development of novel algorithms, models, or strategies.

3. Benchmarking and Evaluation: The generated novel time series data can serve as a benchmark for evaluating the performance of existing algorithms, models, or systems. By comparing the behavior of these algorithms or models on both the original and novel data, organizations can assess their robustness, adaptability, and generalization capabilities.

Use cases include:

1. Fraud Detection: The system 100 can be applied in fraud detection systems to identify anomalous patterns in financial transactions or user behavior, helping to detect fraudulent activities.

2. Intrusion Detection: By detecting deviations from normal patterns in network traffic or system logs, the system 100 can contribute to intrusion detection systems, enhancing cybersecurity measures.

3. Predictive Maintenance: Anomalies detected by the system 100 in equipment sensor data (e.g., aircraft equipment sensor data) can be used to predict and prevent equipment failures, facilitating proactive maintenance strategies.

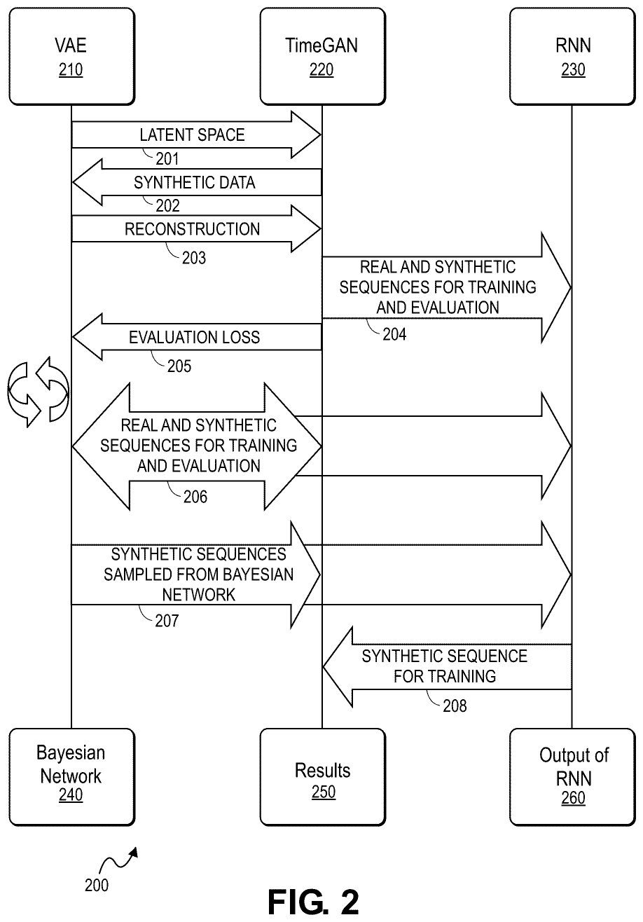

FIG. 2 is a process diagram of a system 200 for generating synthetic time series data according to various embodiments. The system 200 may be a system such as the system 100 as shown and described herein in reference to FIG. 1.

The system 200 includes VAE components 210. In general, a VAE is a generative model that combines the concepts of autoencoders and variational inference. It includes two main components: an encoder network and a decoder network. The encoder network maps the input time series data to a latent space, while the decoder network reconstructs the data from the latent space. An innovation of VAEs lies in their probabilistic interpretation of the latent space. In VAEs, the latent space is modeled as a probability distribution, often assuming a Gaussian distribution. Instead of mapping the input data to a specific point in the latent space, VAEs map it to a distribution characterized by a mean and a variance. The mean represents the most likely representation of the input data, while the variance controls the level of uncertainty or diversity in the generated samples.

During the training phase, VAEs aim to learn the parameters of the latent space distribution that can best reconstruct the input data. This is accomplished by optimizing a joint loss function consisting of two key components: a reconstruction loss and a regularization term. The reconstruction loss measures the discrepancy between the reconstructed data and the original input data, encouraging the model to capture the salient features of the time series. The regularization term, typically based on the Kullback-Leibler (KL) divergence, guides the learned latent space distribution towards a predefined prior distribution, often a standard Gaussian distribution, promoting smoothness and generalization.

VAEs have proven to be effective in various tasks, leveraging their ability to learn meaningful representations and generate synthetic sequences that embody the statistical properties and temporal dependencies of the original data. One prominent application of VAEs in time series data generation is sequence prediction. By training a VAE on historical time series data, they can learn to encode the temporal dependencies and generate future sequences. VAEs offer the advantage of capturing uncertainty by generating multiple plausible future sequences, enabling decision-making under uncertainty.

Another valuable application of VAEs is anomaly detection. VAEs can be trained on normal time series data and used to reconstruct unseen data points. Anomalies can be detected by measuring the reconstruction error, as anomalies often lead to higher reconstruction errors compared to normal data points. VAEs excel at capturing the normal variations and patterns in the data, making them suitable for detecting novel and subtle anomalies.

Long Short-Term Memory (LSTM) networks may be integrated into VAE architectures. LSTM-based VAEs leverage the sequential modeling capabilities of LSTM networks to capture long-term dependencies and temporal dynamics in time series data. By combining the strengths of both VAEs and LSTM networks, these models achieve improved performance in generating realistic and diverse time series sequences.

Further, attention mechanisms may be incorporated into VAE architectures to further enhance their capabilities. Attention mechanisms allow the model to focus on different parts of the input sequence, emphasizing the relevant information for the generation process. This attention-based approach improves the ability of VAEs to capture important patterns and variations in time series data, resulting in more accurate and coherent synthetic sequences. Furthermore, VAEs may be integrated with additional constraints and regularization techniques to enhance the quality of generated sequences. Techniques such as Wasserstein distance, adversarial training, and reinforcement learning may be applied to VAE-based models, to improve the fidelity, diversity, and temporal coherence of the generated time series data. These modification can assist in generating high-quality synthetic time series sequences that exhibit realistic patterns and statistical properties

The system 200 includes TimeGAN components 220. In general, GANs are a class of generative models that include two main components: a generator network and a discriminator network. The generator network learns to generate synthetic data that resembles the real data, while the discriminator network learns to distinguish between the real and synthetic data. The two networks engage in a competitive learning process, iteratively improving their performance through a minimax game.

During training, the generator takes random noise as input and produces synthetic time series sequences. The discriminator, on the other hand, receives both real and synthetic sequences and aims to differentiate between them. Through this adversarial learning process, the generator learns to generate synthetic sequences that are increasingly difficult for the discriminator to distinguish from real data. As training progresses, the generator becomes more adept at capturing the underlying patterns and statistical properties of the real data, resulting in the generation of high-quality synthetic time series sequences.

GANs have the ability to capture the complex dependencies and statistical properties of time series data. By leveraging the adversarial learning framework, GANs excel at generating synthetic time series sequences that closely resemble the characteristics of real data. For example, GANs can learn the underlying distribution of the real data and generate new sequences that are statistically similar. This is particularly valuable in domains where access to large amounts of labeled data is limited or impractical. For example, in financial forecasting, GANs can generate synthetic stock price sequences that capture the trends and volatility observed in real stock market data. Another example is data augmentation. GANs can be trained on a limited dataset and used to generate additional synthetic data points, effectively expanding the size and diversity of the dataset. This augmented data can then be used to improve the performance of machine learning models trained on time series data, leading to better generalization and performance. For instance, in medical research, GANs can generate synthetic patient monitoring data to augment the limited real-world data available for training predictive models.

The general architectural design of GANs can be altered for time series data generation. Variations of GAN architectures, such as conditional GANs (cGANs), Wasserstein GANs (WGANs), and deep convolutional GANs (DCGANs), may address specific challenges and enhance the stability, convergence, and quality of the generated time series sequences. These architectural improvements may generate more diverse, realistic, and coherent synthetic time series data.

Moreover, techniques such as self-attention mechanisms and recurrent neural networks (RNNs) may be integrated into GAN architectures to capture long-term dependencies and temporal dynamics in time series data. Attention mechanisms allow GANs to focus on relevant temporal patterns, improving the generation of coherent and meaningful time series sequences. Recurrent Neural Networks (RNNs), with their sequential modeling capabilities, allow GANs to capture the temporal correlations and dynamics present in time series data, leading to the generation of more accurate and contextually relevant synthetic sequences. The system 200 includes RNNs 230 as described.

GANs have applications in various specific time series domains, such as financial data, healthcare data, and sensor data. By tailoring the GAN models to the specific characteristics and requirements of these domains, they may generate synthetic time series data that exhibits domain-specific statistical properties and patterns. For example, in energy forecasting, GANs may be used to generate synthetic energy consumption profiles that mimic the load patterns and seasonality observed in real energy consumption data.

The system 200 also includes Bayesian network components 240. In general, Bayesian networks are graphical models that represent dependencies between variables using directed acyclic graphs (DAGs). These models provide a powerful framework for probabilistic modeling by capturing both the conditional dependencies and the probabilistic relationships among variables.

In a Bayesian network, each node in the graph represents a random variable, and the edges between nodes represent the probabilistic dependencies between them. The strength and directionality of these dependencies are determined by conditional probability distributions (CPDs), which specify the probability of a node given its parents in the graph. Bayesian networks allow for the representation and manipulation of complex dependencies in a compact and interpretable manner.

Bayesian Networks have the ability to handle uncertainty and incomplete information. Through Bayesian inference, these models facilitate reasoning and inference about uncertain or missing data. They allow for efficient computation of posterior probabilities, enabling the prediction of the states of variables given observed evidence. This capability makes Bayesian networks well-suited for capturing complex dependencies and making probabilistic predictions in various domains.

Bayesian Networks offer a flexible framework for modeling the dependencies and interactions between variables in time series data. By learning the structure and parameters of a Bayesian network from real data, it becomes possible to generate synthetic time series sequences that exhibit similar dependencies and statistical properties.

One of the advantages of using Bayesian Networks for time series data generation is their ability to capture both linear and nonlinear dependencies between variables. The directed acyclic graph structure allows for the modeling of causal relationships and the propagation of information through time. This property allows for the generation of synthetic sequences that reflect the temporal dynamics and causal dependencies observed in the real data.

Furthermore, Bayesian Networks offer the capability to incorporate prior knowledge and expert domain information into the modeling process. By incorporating domain-specific constraints and prior beliefs through prior distributions and CPDs, the generated synthetic sequences can adhere to the known constraints and exhibit the desired characteristics. This feature is particularly valuable in domains where domain knowledge and constraints play a crucial role in generating realistic synthetic data.

Moreover, Bayesian networks provide a principled approach to handle missing data and handle uncertainty. By utilizing the probabilistic nature of the network, missing values can be imputed, and uncertainty can be quantified. This capability contributes to the generation of synthetic time series sequences that are robust to missing data and capture the inherent uncertainty present in real-world time series.

Bayesian networks can be learned from time series data, such as the Chow-Liu algorithm, Bayesian structure learning algorithms, and constraint-based methods. These techniques allow for the automatic discovery of the network structure and the estimation of the CPDs from the observed data. The learned Bayesian network can then be used to generate synthetic time series sequences by sampling from the joint distribution of the variables.

Overall, Bayesian Networks offer a unique perspective and valuable tools for generating synthetic time series data. Their ability to capture dependencies, incorporate prior knowledge, handle uncertainty, and model complex relationships make them a promising framework for generating realistic and high-quality synthetic time series sequences.

The integration of Bayesian network components with VAE components and GAN components in the system 200 can further enhance the generation of synthetic time series data. The combination of these techniques provides a comprehensive framework that captures the underlying structure, preserves statistical properties, and generates synthetic sequences that closely resemble real data.

A description of a non-limiting process for generating synthetic time series data, e.g., results 250, by the system 200 follows.

At 201, the VAE 210 generates data corresponding to input catalyst data in the latent space. The generated data in the latent space is dimensionally reduced in comparison to the input data. The VAE 210 passes the generated data to the TimeGAN 220.

At 202, the TimeGAN 220 synthesizes synthetic data based on the underlying data provided to it. The TimeGAN 220 then passes the synthesized data back to the VAE 210.

At 203, the VAE 210 reconstructs time series data. For example, the VAE reconstructs time series data from the synthesized data in the latent space provided by the TimeGAN 220. The reconstructed data may be in the multivariate space, rather than the latent space.

At 204, the TimeGAN 220 passes real (e.g., the catalyst data) and synthetic time series data to the RNN 230. For example, the synthetic time series data may have originated from 203.

At 205, the TimeGAN 220 passes evaluation loss data to the VAE 210. The evaluation loss data represents dissimilarity between the real and synthetic data and allows the system 200 to score itself. The discriminator component may perform the evaluation.

At 206, the real and synthetic timer series data is passed between the VAE 210, the TimeGAN 220, and the RNN 230. This action may occur multiple times and may include the previous actions, e.g., 201-205.

At 207, the synthetic data is sent through the Bayesian network 240, and synthetic data is sampled from the Bayesian network 240. The synthetic data may be passed to the TimeGAN 220 and RNN 230 as described herein.

At 208, the output of the RNN 260 is passed to the TimeGAN 220, and at 208, the results 250, including the synthetic time series data, are output from the system 200.

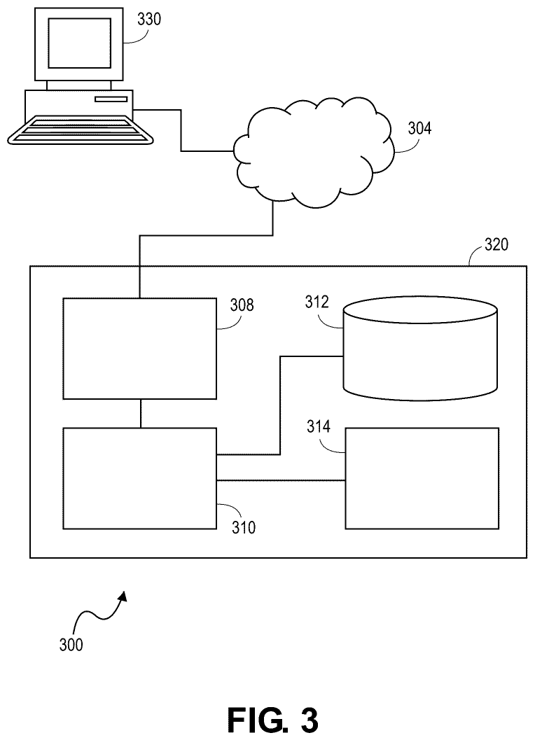

FIG. 3 is a schematic diagram of computer hardware 300 suitable for implementing a system for generating synthetic time series data according to various embodiments. The computer hardware 300 may be used to implement a system such as the system 100 as shown and described herein in reference to FIG. 1 and the system 200 as shown and described herein in reference to FIG. 2.

The computer hardware includes a computer 320. The computer 320 may implement the a system such as the system 100 as shown and described herein in reference to FIG. 1 and the system 200 as shown and described herein in reference to FIG. 2. For example, the computer 320 may generate synthetic multivariate time series data as shown and described herein. The computer 320 can be a laptop, desktop, or tablet computer, can be incorporated in one or more workstations, servers, clusters, or other computers or hardware resources, or can be implemented using cloud-based resources. The software stack of the computer 320 may include an operating system such as Linux or Windows, programming languages like Python or R, and libraries/frameworks such as TensorFlow or PyTorch for deep learning, scikit-learn for machine learning, and pandas for data manipulation.

The computer 320 includes a processor 310 and volatile memory 314. The processor 310 may be implemented as a singe-core processor, a multi-core processor, one or more Graphical Processing Units (GPUs), or a combination thereof. The volatile memory may include Random Access Memory (RAM), or any other volatile memory, and may be used by the processor 310 during execution of any processes executed by the processor 310.

The computer 320 includes a persistent memory 312, which can store computer-readable instructions, that, when executed by the electronic processor 310, configure computer 320 to at least partially perform any of the computer-implemented methods shown and described herein. For example, the computer-readable instructions can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary persistent memory 312 includes ROM (read-only memory), EPROM (erasable, programmable ROM), EEPROM (electrically erasable, programmable ROM), flash memory, and magnetic or optical disks or tapes.

The computer 320 is communicatively coupled to network 304 via network interface 308. Other configurations of system 300, associated network connections, and other hardware, software, and service resources are possible.

The system 300 also includes a computer 330, which is communicatively coupled to the computer 320 via the network 304. The computer 330 may accept synthetic multivariate time series data generated by the computer 320 and use such data for any of a variety of purposes as disclosed herein. By way of non-limiting example, the computer 330 may use aircraft synthetic multivariate time series data to train a machine learning system, e.g., to predict faults in an aircraft.

In general, aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented using computer readable program instructions that are executed by an electronic processor. That is, certain examples can be performed using a computer program or set of programs. The computer programs can exist in a variety of forms both active and inactive.

These computer readable program instructions may be provided to a processor of a general-purpose computer, special purpose computer, or other programmable data processing apparatus to produce a machine, such that the instructions, which execute via the electronic processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In embodiments, the computer readable program instructions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on a user's computer, partly on the user's computer, as a stand-alone software package, partly on the user's computer and partly on a remote computer or entirely on the remote computer or server.

As used herein, the terms “A or B” and “A and/or B” are intended to encompass A, B, or {A and B}. Further, the terms “A, B, or C” and “A, B, and/or C” are intended to encompass single items, pairs of items, or all items, that is, all of: A, B, C, {A and B}, {A and C}, {B and C}, and {A and B and C}. The term “or” as used herein means “and/or.”

As used herein, language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

While the invention has been described with reference to the exemplary examples thereof, those skilled in the art will be able to make various modifications to the described examples without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A computer-implemented machine learning system for generating synthetic time series data, the system comprising:
an embedder network that inputs multivariate time series data and produces latent representations capturing temporal dependencies, wherein the multivariate time series data comprises initial multivariate time series data;
a recovery network that produces reconstructed multivariate time series data from the latent representations, wherein the recovery network employs a plurality of time-distributed dense layers that maintain statistical properties; and
a generator network that synthesizes synthetic multivariate time series data from the latent representations, wherein the synthetic multivariate time series data reflects temporal patterns of the initial multivariate time series data.

2. The system of claim 1, wherein the embedder network comprises a series of long short-term memory (LSTM) layers to encode the initial multivariate time series data into a lower-dimensional latent space, capturing both short-term and long-term temporal dependencies.

3. The system of claim 1, wherein the recovery network utilizes a combination of LSTM layers and time-distributed dense layers to decode the latent representations into decoded multivariate time series data, wherein the decoded multivariate data aligns with temporal and statistical characteristics of the initial multivariate time series data.

4. The system of claim 1, wherein the generator network is trained adversarially in conjunction with a discriminator network, wherein the discriminator network is trained to differentiate between authentic and synthetic multivariate time series data.

5. The system of claim 4, wherein the embedder network and the recovery network undergo, prior to the generator network being trained adversarially in conjunction with the discriminator network, an initial training phase to stabilize latent space representations.

6. The system of claim 1, further comprising a Bayesian network that models conditional probability distributions and causal relationships within the initial multivariate time series data.

7. The system of claim 1, wherein the system comprises an integration of components from a temporal generative adversarial network (TimeGAN), a variational autoencoder (VAE), and a recurrent neural network (RNN).

8. The system of claim 1, wherein the synthetic multivariate time series data is used to train a separate machine learning model.

9. The system of claim 1, wherein the synthetic multivariate time series data comprises aircraft time series data.

10. The system of claim 9, wherein the synthetic multivariate time series data comprises at least two of: parametric aircraft data, aircraft fault data, aircraft maintenance data, aircraft binary data, or aircraft flight data.

11. A non-transitory computer readable medium comprising instructions that, when executed by an electronic processor, configure the electronic processor as a computer-implemented machine learning system for generating synthetic time series data, the system comprising:
an embedder network that inputs multivariate time series data and produces latent representations capturing temporal dependencies, wherein the multivariate time series data comprises initial multivariate time series data;
a recovery network that produces reconstructed multivariate time series data from the latent representations, wherein the recovery network employs a plurality of time-distributed dense layers that maintain statistical properties; and
a generator network that synthesizes synthetic multivariate time series data from the latent representations, wherein the synthetic multivariate time series data reflects temporal patterns of the initial multivariate time series data.

12. The non-transitory computer readable medium of claim 11, wherein the embedder network comprises a series of long short-term memory (LSTM) layers to encode the initial multivariate time series data into a lower-dimensional latent space, capturing both short-term and long-term temporal dependencies.

13. The non-transitory computer readable medium of claim 11, wherein the recovery network utilizes a combination of LSTM layers and time-distributed dense layers to decode the latent representations into decoded multivariate time series data, wherein the decoded multivariate data aligns with temporal and statistical characteristics of the initial multivariate time series data.

14. The non-transitory computer readable medium of claim 11, wherein the generator network is trained adversarially in conjunction with a discriminator network, wherein the discriminator network is trained to differentiate between authentic and synthetic multivariate time series data.

15. The non-transitory computer readable medium of claim 14, wherein the embedder network and the recovery network undergo, prior to the generator network being trained adversarially in conjunction with the discriminator network, an initial training phase to stabilize latent space representations.

16. The non-transitory computer readable medium of claim 11, wherein the system further comprises a Bayesian network that models conditional probability distributions and causal relationships within the initial multivariate time series data.

17. The non-transitory computer readable medium of claim 11, wherein the system comprises an integration of components from a temporal generative adversarial network (TimeGAN), a variational autoencoder (VAE), and a recurrent neural network (RNN).

18. The non-transitory computer readable medium of claim 11, wherein the synthetic multivariate time series data is used to train a separate machine learning model.

19. The non-transitory computer readable medium of claim 11, wherein the synthetic multivariate time series data comprises aircraft time series data.

20. The non-transitory computer readable medium of claim 19, wherein the synthetic multivariate time series data comprises at least two of: parametric aircraft data, aircraft fault data, aircraft maintenance data, aircraft binary data, or aircraft flight data.
